(19) United States
(12) Patent Application Publication
(10) Pub. No.: US 2011/0029728 A1
(43) Pub. Date: Feb. 3, 2011

(54) METHODS AND APPARATUS FOR REDUCING INPUT/OUTPUT OPERATIONS IN A RAID STORAGE SYSTEM

(75) Inventors: Vladimir Popovski, Irvine, CA (US); Nelson Nahum, Tustin, CA (US); Jeffrey E. Odell, Irvine, CA (US)

Correspondence Address: Duft Bornsen & Fishman LLP, 1526 Spruce Street, Suite 302, Boulder County, CO, 80302, US

(73) Assignee: LSI CORPORATION, Milpitas, CA (US)

(21) Appl. No.: 12/510,727

(22) Filed: Jul. 28, 2009

(51) Int. Cl. G06F 12/08

(52) U.S. Cl. 711/114; 711/E12.019

(57) ABSTRACT

Methods and systems for managing RAID volumes are disclosed. Metadata is associated with storage devices that comprise a RAID volume. The metadata identifies each of a plurality of portions as being either initialized or non-initialized. The number of I/O operations performed by a storage controller coupled with the storage devices is reduced in response to a request for the RAID volume based on the metadata.

### BACKGROUND

1. Field of the Invention

The invention relates generally to reducing input/output (I/O) operations in a RAID storage system, and more specifically, relates to identifying written (initialized) and non-written (non-initialized) portions on storage devices of RAID volumes for improved volume creation and rebuild performance.

2. Related Patents

This patent is related to commonly owned United States patent application having LSI Docket Number 08-1355 and entitled METHOD AND APPARATUS FOR METADATA MANAGEMENT IN A STORAGE SYSTEM which is hereby incorporated by reference.

3. Discussion of Related Art

Storage subsystems have evolved along with associated computing subsystems to improve performance, capacity, and reliability. Redundant arrays of independent disks (i.e., “RAID” subsystems) provide improved performance by utilizing striping features and provide enhanced reliability by adding redundancy information. Performance is enhanced by utilization of so called “striping” features in which one I/O request for reading or writing is distributed over multiple simultaneously active disk drives to thereby spread or distribute the elapsed time waiting for completion over multiple, simultaneously operable disk drives. Redundancy is accomplished in RAID subsystems by adding redundancy information such that the loss/failure of a single disk drive of the plurality of disk drives on which the host data and redundancy information are written will not cause loss of data. Despite the loss of a single disk drive, no data will be lost though in some instances the logical volume will operate in a degraded performance mode.

RAID storage management techniques are known to those skilled in the art by a RAID management level number. The various RAID management techniques are generally referred to as “RAID levels” and have historically been identified by a level number. RAID level 5, for example, utilizes exclusive-OR (“XOR”) parity generation and checking for such redundancy information. Whenever data is to be written to the storage subsystem, the data is “striped” or distributed over a plurality of simultaneously operable disk drives. In addition, XOR parity data (redundancy information) is generated and recorded in conjunction with the supplied data from the write request. In like manner, as data is read from the disk drives, striped information may be read from multiple, simultaneously operable disk drives to thereby reduce the elapsed time overhead required completing a given read request. Still further, if a single drive of the multiple independent disk drives fails, the redundancy information is utilized to continue operation of the associated logical volume containing the failed disk drive. Read operations may be completed by using remaining operable disk drives of the logical volume and computing the XOR of all blocks of a stripe that remain available to thereby re-generate the missing or lost information from the inoperable disk drive. Such RAID level 5 storage management techniques for striping and XOR parity generation and checking are well known to those of ordinary skill in the art.

Other RAID storage management levels provide still other degrees of improved reliability and/or performance. As used herein, “storage subsystem” or “storage system” refers to all such storage methods and structures where striping and/or RAID storage management techniques are employed.

Typically storage subsystems include a storage controller responsible for managing and coordinating overall operation of the storage subsystem. The storage controller is generally responsible for receiving and processing I/O requests from one or more attached host systems requesting the reading or writing of particular identified information. In addition, the internal architecture of methods operable within the storage controller may frequently generate additional I/O requests. For example, in the context of a RAID level 5 storage subsystem, additional read and write I/O operations may be generated to retrieve and store information associated with the generation and checking of the XOR parity information managed by the storage controller. In like manner, additional I/O requests may be generated within a storage controller when rebuilding or regenerating a RAID volume in response to failure and replacement of one or more storage devices. Still further, other internally generated I/O operations may relate to reorganizing information stored in a logical volume of a storage subsystem. Logical volumes comprise logical block addresses mapped to physical storage on portions of one or more storage devices. Those of ordinary skill in the art will readily recognize a wide variety of operations that may be performed by a storage controller of the storage system that may generate I/O requests internal to the storage controller to be processed substantially concurrently with other internally generated I/O requests and substantially concurrently with ongoing I/O requests received from attached host systems.

When rebuilding a RAID volume after a storage device failure, a significant amount of time may be necessary for the process. After the failed storage device is replaced with a new storage device, typically the storage controller uses information remaining on the non-failed storage devices of the logical volume to recalculate the data for the new storage device (i.e., a “rebuild” process). During the rebuild process, each segment or portion (i.e., each block) of the new storage device is written by recalculating values from the information on the non-failed storage devices. As presently practiced, each portion of the new storage device is written regardless of whether any valid data is actually contained on the failed portions for the RAID volume. In a similar manner, creating a RAID volume may involve numerous redundancy calculations as redundancy information is calculated and written to the storage devices of the logical volume. Additionally, unless the storage controller initializes the storage devices in the logical volume with pre-determined initialized values during the logical volume creation process, a potential exists for latent data from a previously created logical volume to remain within the new logical volume. Such latent or residual data may be overwritten to enhance security in present storage systems when a new logical volume is defined. This initialization of a newly created logical volume can consume significant time in a storage system.

Thus it is an ongoing challenge to improve creation and rebuild performance in RAID storage systems.

### SUMMARY

The present invention solves the above and other problems, thereby advancing the state of the useful arts, by providing methods and systems for reducing I/O operations in a RAID storage system. I/O operations may be reduced by identifying initialized and non-initialized portions of storage devices of a RAID volume, and reducing the number of I/O operations based on the identified portions. By reducing the number of I/O operations, processor loading of the storage system is reduced, and consequently, the number of I/O operations per second generated by the storage system may be increased. Increasing the number of I/O operations per second generated by the storage system increases the performance of the storage system.

In one aspect hereof, a method is provided for managing a RAID volume by associating metadata with storage devices in the RAID volume. The metadata identifies each of a plurality of portions of the storage devices as being either initialized or non-initialized. The number of I/O operations performed by the storage controller is reduced in response to a request for the RAID volume based on the metadata.

Another aspect hereof provides a RAID storage system. The storage system comprises a plurality of storage devices comprising a RAID volume and a storage controller. The storage controller comprises a request module, an I/O processing module, a metadata analyzing module, a metadata storage module, and a metadata updating module. The request module is operable to receive a request for the RAID volume. The I/O processing module is operable to perform I/O operations for the storage devices in response to an I/O request and to reduce the number of I/O operations performed in response to the response to the I/O request for the RAID volume based on the metadata. The metadata analyzing module is operable to identify the initialized portions and the non-initialized portions of the storage devices from the metadata. The metadata storage module is operable to store metadata associated with the storage devices, where the metadata identifies each of a plurality of portions of the storage devices as being either initialized or non-initialized. The metadata updating module is operable to update the metadata.

### BRIEF DESCRIPTION OF THE DRAWINGS

FIG. 1 is a block diagram of an exemplary RAID storage system in accordance with features and aspects herein to reduce I/O operations for RAID volumes.

FIG. 2 depicts exemplary storage devices illustrating a plurality of initialized and non-initialized portions in accordance with features and aspects herein.

FIG. 3 depicts exemplary storage devices illustrating replacement of a failed storage device in accordance with features and aspects herein.

FIG. 4 is a flowchart describing an exemplary method in accordance with features and aspects hereof for reducing I/O operations within RAID storage systems.

FIGS. 5-8 are flowcharts describing exemplary additional details of aspects of the method of FIG. 4.

FIG. 9 is a flowchart describing exemplary additional steps of the method of FIG. 4.

### DETAILED DESCRIPTION OF THE DRAWINGS

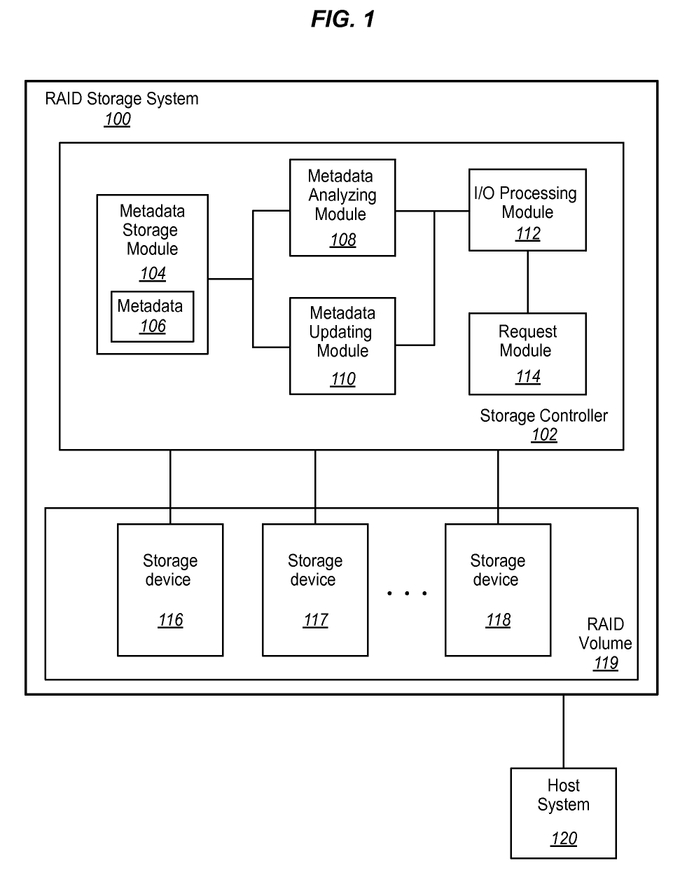

FIG. 1 is a block diagram of an exemplary RAID storage system enhanced in accordance with features and aspects herein to provide reduced I/O operations for RAID volumes. RAID storage system 100 includes a plurality of storage devices 116-118 comprising a RAID volume 119 coupled with a storage controller 102. Storage devices 116-118 may include a variety of types of devices operable for persistently storing data, such as hard disk drives, flash disk drives, battery backed random access memory drives (also known as “ramdisks”), or other types of devices operable for persistently storing data. Storage devices 116-118 may be electrically coupled with storage controller 102 using any number of interfaces, such as parallel or serial attached SCSI, parallel or serial ATA, IDE, FIBRE channel, or other interfaces operable for transmitting and receiving data between storage controller 102 and storage devices 116-118. Although RAID volume 119 is illustrated as including storage devices 116-118, one skilled in the art will recognize that RAID volume 119 may comprise any number of storage devices and/or a subset of storage devices 116-118, and/or a subset of portions of storage devices 116-118. FIG. 1 additionally illustrates a host system 120, which may be coupled with RAID storage system 100. Host system 120 may generate specific requests for RAID volume 119, such as read requests, write requests, rebuild requests, or other types of requests for RAID volume 119. Another exemplary request may be to initially create RAID volume 119 and initialize it accordingly.

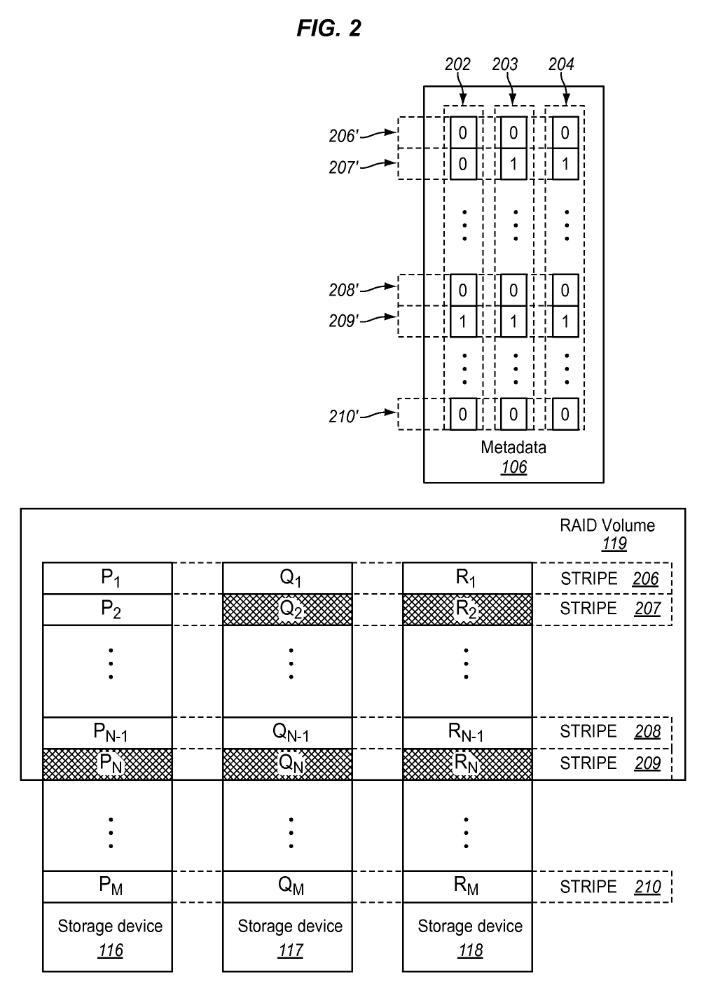

Storage controller 102 of RAID system 100 further includes a metadata storage module 104 for storing metadata 106. Metadata storage module 104 is operable to store metadata 106 associated with storage devices 116-118. In accordance with features and aspects herein, metadata storage module 104 may include non-volatile memory, such as non-volatile ram or flash memory. Metadata 106 is used to identify portions of storage devices 116-118 as being either initialized or non-initialized. FIG. 2 exemplifies metadata corresponding to exemplary storage devices 116-118, respectively. FIG. 2 depicts storage devices 116-118 illustrating a plurality of portions P₁-P_{M}, Q₁-Q_{M}, and R₁-R_{M} for each of storage devices 116-118. The plurality of portions P₁-P_{M}, Q₁-Q_{M}, and R₁-R_{M} represent a logical partitioning of the storage devices 116-118 into portions of storage. For example, if storage device 116 had a storage capacity of 1 TB and was segmented into 1,000 portions, then portions P₁-P_{M} of FIG. 2 would each represent 1 GB of storage for storage device 116. In some cases portions are initialized and are highlighted to so indicate, such as P_{N}. Initialized portion P_{N} contains data for RAID volume 119 that was previously written to some supplied data value and/or initialized to some predetermined value. Correspondingly, non-initialized portion P₁ of FIG. 2 does not contain data for RAID volume 119, and is not highlighted to so indicate. Storage controller 102 is operable to use metadata 106 to reduce the number of I/O operations by determining from metadata 106 which portions of storage devices 116-118 are either initialized or non-initialized.

FIG. 2 additionally illustrates RAID volume 119 as an example of a RAID 5 management level comprising stripes 206-209 of data across storage devices 116-118. Stripes 206-209 of RAID volume 119 include portions P₁-P_{N}, Q₁-Q_{N}, and R₁-R_{N} of storage devices 116-118. Stripes may include any combination of initialized portions and non-initialized portions. For example, stripe 206 of RAID volume 119 includes non-initialized portions P_{1,} Q₁, and R₁. Although RAID volume 119 has been illustrated as comprising specific portions of storage devices 116-118 and as a RAID 5 management level, one skilled in the art will recognize that RAID volume 119 may comprise any number of portions illustrated in FIG. 2 and may include other RAID management levels not shown, such as RAID 6. Additionally, one skilled in the art will recognize that storage devices 116-118 may include other RAID volumes not illustrated along with RAID volume 119, for example, an additional RAID volume including stripe 210.

FIG. 2 additionally illustrates an exemplary detailed view of metadata 106. Metadata 106 includes bit tables 202-204, each bit table associated with a corresponding storage device 116-118. Bit tables 202-204, respectively may be logically grouped to include rows 206′-210′ which correspond to stripes 206-210 of storage devices 116-118. Each bit in bit tables 202-204 indicate whether a corresponding portion of storage devices 116-118 is either initialized or non-initialized. For example, bit table 202 for storage device 116 indicates non-initialized portions P₁-P_{N-1} and P_{M} as zero bit values and initialized portion P_{N} as a 1 bit value (e.g., row 209′). Although metadata 106 has been illustrated as including three bit tables 202-204, one skilled in the art will recognize that any number of bit tables may be provided, each corresponding to a storage device (including storage devices 116-118 and/or others not shown).

Referring again to FIG. 1, storage controller 102 further includes a request module 114 coupled with an I/O processing module 112. Request module 114 is operable to receive I/O requests for RAID volume 119 (e.g., from host system 120 or generated internally by controller 102). The I/O requests may include write requests, read requests, logical volume creation requests, rebuild requests, or other types of requests for RAID volume 119. I/O processing module 112 is operable to perform I/O operations for storage devices 116-118 in response to I/O requests received by request module 114. I/O processing module 112 is further operable to reduce the number of I/O operations performed in response to the I/O requests for RAID volume 119 based on metadata 106. By reducing the number of I/O operations performed in response to the I/O requests, the computational load on I/O processing module 112 is reduced. Consequently, the number of I/O operations per second generated by I/O processing module 112 may be increased, which may increase the performance of RAID volume 119.

Storage controller 102 additionally includes a metadata analyzing module 108 coupled with metadata storage module 104 and I/O processing module 112. Metadata analyzing module 108 is operable to identify initialized portions and non-initialized portions of storage devices 116-118 from metadata 106 of metadata storage module 104 in response to a request by I/O processing module 112. For example, metadata analyzing module 108 may read bit table 202 of FIG. 2 in metadata 106 from metadata storage module 104, and identify each bit in bit table 202 to identify initialized portion P_{N} and non-initialize portions P₁-P_{N-1} and P_{M} for storage device 116.

Storage controller 102 additionally includes a metadata updating module 110 coupled with I/O processing module 112 and metadata storage module 104. Metadata updating module 110 is operable to update metadata 106. For example, request module 114 may receive an I/O request, such as a write request, and forward it to I/O processing module 112 to process the write request. I/O processing module 112 may instruct metadata analyzing module 108 to read metadata 106 from metadata storage module 104. I/O processing module 112 may identify portions of metadata 106 to change based on portions of storage devices 116-118 affected by the write request. I/O processing module 112 may then instruct metadata updating module 110 to update metadata 106 based on the identified portions of metadata 106 to change. When updating metadata 106, metadata updating module 110 may read bit table 202 of FIG. 2 in metadata 106 from metadata storage module 104, update bits in bit table 202, and write an updated version of bit table 202 back to metadata storage module 104.

In accordance with features and aspects herein, metadata updating module 110 may store metadata 106 on storage devices 116-118. In accordance with other features and aspects herein, metadata updating module 110 may maintain an updated copy of metadata 106 on storage devices 116-118 by copying metadata 106 from metadata storage module 104 to storage devices 116-118. For example, storage controller 102 may copy bit table 203 associated with storage device 117 onto storage devices 116 and 118. Thus, if storage device 117 were to fail, metadata 106 associated with storage device 117 (i.e., bit table 203) would be available for rebuilding storage device 117 after replacing storage device 117 with a new storage device. Additionally, storage controller 102 may copy only portions of metadata 106 stored on storage devices 116-118 into metadata storage module 104. For example, if metadata 106 included a large set of data not readily held completely within metadata storage module 104, then storage controller 102 may swap out portions of metadata 106 from one or more storage device 116-118 and hold the portions in metadata storage module 104 as needed. Additionally, copying metadata 106 from metadata storage module 104 to storage devices 116-118 may occur responsive to storage controller 102 being idle or responsive to expiration of a fixed or variable period of time.

Reliable storage and prevention of loss of metadata 106 is an important consideration when implementing RAID storage system 100. A subsequent loss or corruption of metadata 106 may result in lost or corrupted information regarding initialized and non-initialized portions of RAID volume 119. As a consequence, RAID volume 119 may become degraded or may fail. In order to ensure the reliable storage and prevention of loss of metadata 106, a number of options are available when storing metadata 106. For example, metadata 106 may be stored in non-volatile memory within metadata storage module 104, such as in flash memory or battery backed RAM.

Metadata 106 may also be stored redundantly on one or more storage devices 116-118. For example, in one configuration, metadata for 4 storage devices (the storage devices indicated as A, B, C, D in table 1 below) may include metadata tables Ta, Tb, Tc, and Td. Each table indicating metadata for a corresponding storage device (i.e., metadata table Ta corresponds to metadata for storage device A). In this example, metadata and redundancy information may be reliably stored using a RAID 5 management level configuration. Redundancy information for a specific metadata table is indicated as Xn. For example, redundancy information Xa would correspond to metadata table Ta. An exemplary configuration appears as indicated in table 1 below.

TABLE 1

| A | B | C | D |
|---|---|---|---|
| Ta | — | — | Xa |
| — | Tb | — | Xb |
| — | — | Tc | Xc |
| Xd | — | — | Td |

In Table 1, metadata table Ta and redundancy information Xd are reliably stored on storage device A. If storage device A were to fail and subsequently be replaced with a new storage device, Metadata table Ta may be re-calculated and written to the new storage device from redundancy information Xa. Additionally, redundancy information Xd may be re-calculated from metadata table Td.

In some cases, it may be desirable to store metadata tables for specific storage devices on other storage devices. For example, it may be desirable to store metadata associated with storage device A on storage device B. Another exemplary configuration illustrating this concept appears as indicated in table 2 below.

TABLE 2

| A | B | C | D |
|---|---|---|---|
| — | Ta | — | Xa |
| Xb | — | Tb | — |
| — | Xc | — | Tc |
| Td | — | Xd | — |

Table 2 illustrates reliably storing metadata tables Ta, Tb, Tc, and Td on storage devices A-D. In Table 2, metadata tables for specific storage devices are reliably stored on other storage devices. In table 2, metadata table Ta is stored on storage device B. Additionally, redundancy information for metadata table Ta (i.e., Xa) is stored on storage device D. In cases where storage device B fails and subsequently is replace with a new storage device, metadata table Ta may be re-calculated and written to the new storage device using redundancy information Xa. Additionally, redundancy information Xc may be re-calculated from metadata table Tc. Thus, reducing the possibility of loss or corruption of metadata associated with storage devices.

In other configurations, the metadata and redundancy information may be reliably stored as indicated in the exemplary configuration of Table 3 below.

TABLE 3

| A | B | C | D |
|---|---|---|---|
| Ta | Tb | Tc | Xabc |
| Td | — | — | Xd |

In table 3, redundancy information Xabc stored on storage device D corresponds to metadata tables Ta, Tb, and Tc. Additionally, metadata table Td is stored on storage device A and redundancy information Xd for metadata table Td is stored on storage device D.

Although specific examples of reliably storing metadata on 4 storage devices are shown, one skilled in the art will recognize that a number of configurations are possible. Additionally, although 4 storage devices are shown in a RAID 5 management level with specific metadata configurations, one skilled in the art will recognize that other RAID management levels and metadata configurations exist to store metadata redundantly on a number of storage devices.

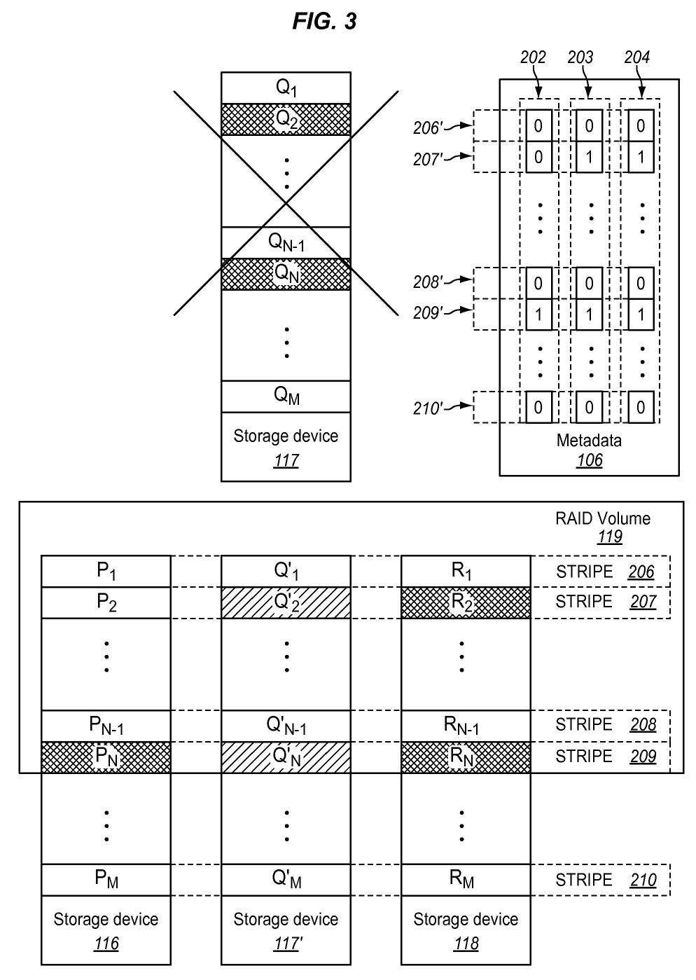

If one or more storage devices 116-118 fail, storage controller 102 may perform a rebuild process to recover the data lost on the failed storage devices. FIG. 3 is a block diagram of exemplary storage devices 116-118 and 117′ illustrating replacement of a failed storage device 117 with replacement storage device 117′ and associated use and management of metadata 106 in accordance with features and aspects herein.

As presently practiced, rebuilding a RAID volume comprises rebuilding all portions on a replacement storage device, regardless of whether any valid data is contained on a portion (i.e., non-initialized portions). Thus, if a RAID volume contained many non-initialized portions on storage devices, un-necessary rebuild processing would occur, which may involve a significant amount of time for completion. For example, a prior art storage system may rebuild thousands of portions of a storage device after a storage device failure regardless of the fact that the storage device may not contain any initialized portions at all.

In contrast to a prior art storage system, RAID storage system 100 is operable to perform a rebuild process on RAID volume 119 after replacing failed storage device 117 with replacement storage device 117′. The rebuild process is performed by writing data only on initialized portions Q′₂ and Q′_{N} of storage devices 116 and 118, as identified by bit table 202 of metadata 106.

During a rebuild process, a number of redundancy information calculations are typically performed, which generate a number of I/O operations. The number of I/O operations may be reduced using metadata 106. For example, when rebuilding data for a portion of a failed storage device, a typical prior art system may read information from other portions of non-failed storage devices, XOR the values together (when RAID volume is a RAID 5 volume) to recover data for the failed portion. This operation entails two reads (in a 3 device RAID 5 array) and one write.

RAID storage system 100 is enhanced in accordance with features and aspects herein to reduce the I/O operations performed in such redundancy calculations by using metadata 106. For example, when rebuilding initialized portion Q′₂ on storage device 117′ (See FIG. 3), metadata 106 may be read to identify portion P₂ as being non-initialized. After identifying portion P₂ as non-initialized, pre-determined initial values (e.g., zeros in the case of RAID 5) are used for non-initialized portion P₂ when performing the redundancy calculation for initialized portion Q′₂. This exemplary enhanced operation eliminates one read operation on storage device 116 and therefore reduces the number of I/O operations performed during the rebuild process.

Another type of request processed by storage controller 102 is a logical volume creation request. For example, RAID volume 119 may be created from portions P₁-P_{N}, Q₁-Q_{N}, and R₁-R_{N} of storage devices 116-118 (See FIG. 2). For example, a number of RAID management levels could be created, such as RAID 5, RAID 6, RAID 50 or RAID 60. Responsive to the request, metadata 106 is updated to indicate that all portions P₁-P_{N}, Q₁-Q_{N}, and R₁-R_{N} in logical volume 119 are non-initialized. This may be performed by, for example, clearing bits contained in bit tables 202-204 along rows 206′-209′ of FIG. 2 to indicate that portions P₁-P_{N}, Q₁-Q_{N}, and R₁-R_{N} of storage devices 116-118 are non-initialized. After clearing the bits, no I/O operations need be performed on any storage devices 116-118. In contrast, the present practice of creating a RAID volume may generate a number of I/O operations as redundancy information calculations are performed on pre-existing data within the newly created RAID volume. Additionally, the present practice may instead include writing pre-determined values to overwrite any pre-existing data within the newly created RAID volume. In contrast to such current practices, the enhanced rebuild process in accordance with features and aspects herein for RAID volume 119 is advantageously faster.

Another type of request processed by storage controller 102 for RAID volume 119 is a read request. Responsive to receiving a read request, metadata 106 is analyzed to determine if any part of the read request corresponds to non-initialized portions of storage devices 116-118. If any part of the read request corresponds to non-initialized portions, pre-determined initial values (e.g., zeros) are returned without performing an I/O operation to read the non-initialized portion. For example, a read request may be processed which includes reading data for non-initialized portion P₂. When returning data for part of the read request corresponding to non-initialized portion P₂, zero value data is returned without performing a read operation on storage device 116. By not performing an I/O read operation on storage device 116, the number of I/O operations is reduced.

Another type of request processed by storage controller 102 for RAID volume 119 is a write request. In some cases, the write request corresponds to writing an entire stripe of data, commonly known in the art as a “stripe write” or “full stripe write” (e.g., writing the entire stripe 208 of FIG. 2). Responsive to processing the stripe write request, metadata 106 is updated to indicate that any portions of storage devices 116-118 change from non-initialized to initialized. For example, if a stripe write was performed on stripe 208 of RAID volume 119 (See FIG. 2), metadata 106 would be updated such that un-initialized portions P_{N-1}, Q_{N-1}, and R_{N-1} are now indicated as initialized. This may be accomplished by writing binary 1's to row 208′ for bit tables 202-204 of metadata 106.

In other cases, the write request corresponds to writing a portion of a stripe of data, commonly known in the art as a “read-modify-write” operation or a “partial stripe write” operation. As presently practiced (in a RAID 5 volume) a stripe is read, modified with the portion or portions of data to be written, and an XOR calculation is performed on the data of the stripe to calculate new redundancy information. Then, either the entire stripe may be re-written or the new redundancy information is written along with the new portion or portions of data for the stripe (i.e., a partial write).

In contrast to the present practice and in according to features and aspects herein, RAID storage system 100 (See FIG. 1) is operable to reduce the number of I/O operations performed in a read-modify-write operation using metadata 106. Metadata 106 may be used to reduce the number of I/O operations by identifying non-initialized portions of a partial stripe write and utilizing zero or pre-determined values for the non-initialized portions without performing an I/O operation.

Metadata 106 may also be used to reduce the number of I/O operations in processing a read-modify-write operation by utilizing pre-calculated redundancy information values based on the non-initialized portions of the partial stripe write. For example, if non-initialized portion Q_{N-1} in a RAID 5 example (See FIG. 2) is written in a partial stripe write operation, metadata 106 may be analyzed to determine that other portions in the stripe (i.e., P_{N-1} and R_{N-1}) are non-initialized. Using this information, pre-determined values would be used for P_{N-1} and R_{N-1}, thus eliminating read operations on storage devices 116 and 118 when calculating redundancy information for the stripe. Additionally, pre-calculated redundancy information values (e.g., all zero's in a RAID 5 volume) could be used. Both enhancements advantageously reduce the number of I/O operations performed by storage controller 102.

Although the previous features and aspects have been described in terms of ‘modules’ in enhanced controller 102 of FIG. 1, one skilled in the art will recognize that the various modules previously described may be implemented as electronic circuits, programmable logic devices, a custom ASIC (application specific integrated circuit), computer instructions executing on a processing system, and other combinations of hardware and software implementations. Furthermore, the exemplary modular decomposition of FIG. 1 may be implemented as more, less, or different modules as a matter of design choice. Still further, although FIGS. 1-3 have been described with specific reference to an exemplary RAID 5 volume, one skilled in the art will recognize that logical volumes using other RAID management levels may similarly apply to features and aspects hereof.

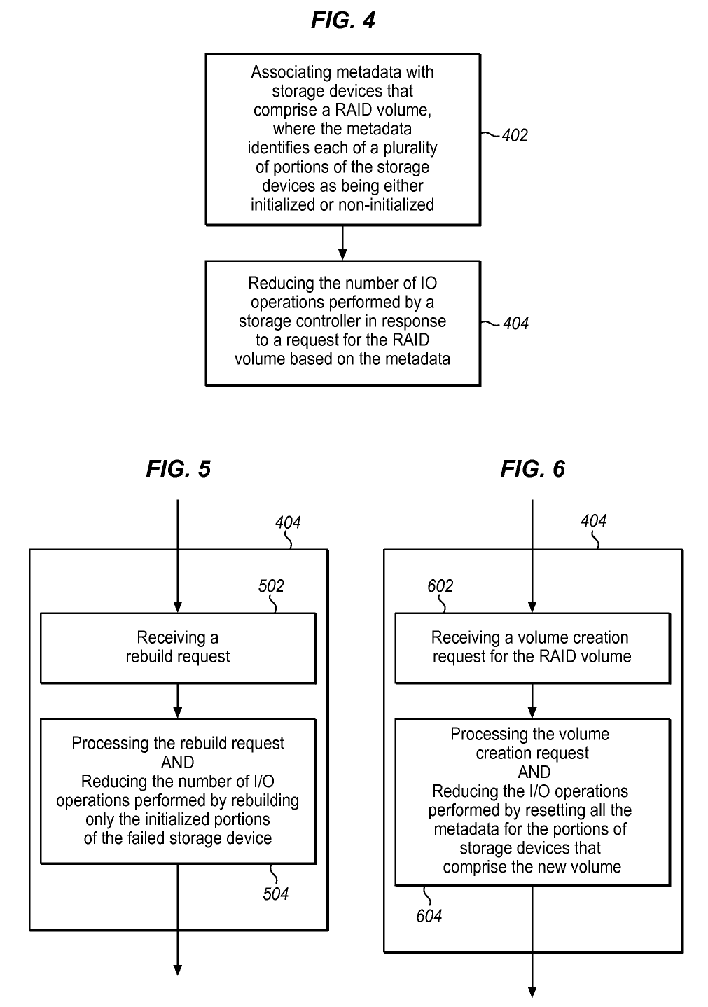

FIG. 4 is a flowchart describing an exemplary method in accordance with features and aspects hereof for reducing the number of I/O operations within RAID storage systems. In accordance with features and aspects herein, the method of FIG. 4 may be performed by storage controller 102 of RAID storage system 100 embodied as computer readable instructions executed by a general purpose processor, or by custom hardware circuits, programmable logic, and the like.

Step 402 comprises associating metadata with storage devices that comprise a RAID volume. The metadata identifies each of a plurality of portions of the storage devices as being either initialized or non-initialized. In accordance with features and aspects herein, the metadata may be stored in a memory on a storage controller and/or persistently stored on the storage devices. For example, the metadata for each storage device may be stored on other storage devices in a storage system or volume group. In accordance with features and aspects herein, the metadata may comprise bit tables associated with each storage device, such as described previously.

Step 404 comprises reducing the number of I/O operations performed by the storage controller in response to an I/O request for the RAID volume based on the metadata. For example, the metadata may be analyzed to determine initialized and non-initialized portions of the RAID volume, and correspondingly, I/O operations may be reduced by avoiding rebuilding or reading portions of the RAID volume determined to be non-initialized and by avoiding writing any initialization data when creating a RAID logical volume.

FIGS. 5-8 are flowcharts describing exemplary additional details of aspects of the method of FIG. 4 in which various types of requests are processed with reduced I/O operations by use of the metadata.

Step 502 of FIG. 5 comprises receiving a rebuild request for the RAID volume. Such a request is issued such as when a failed device in a RAID volume is replaced by another device. The data on the failed device is rebuilt onto the replacement device using data on the other devices of the RAID volume.

Step 504 comprises reducing the number of I/O operations performed while processing the rebuild request by using the metadata. Initialized portions and non-initialized portions of the storage devices are identified by the metadata. A rebuild process is performed on a replacement storage device of the RAID volume by writing data only to the initialized portions of the replacement storage device as identified by the metadata. If, for example, a storage device failed on a RAID 5 volume, the metadata would identify the initialized portions of the failed storage device after replacement of the storage device. During the rebuild process, only the initialized portions would be rebuilt on the replacement storage device, thus reducing the number of I/O operations performed during the rebuild process

Step 602 of FIG. 6 comprises receiving a volume creation request for a RAID volume. Such a request is issued by an administrator user or any management utility or application to create a new RAID volume from portions of multiple storage devices. Creating a new RAID volume entails generally initializing data on the portions of the devices that comprise the volume and assuring the consistency of redundancy information on the newly created volume.

Step 604 comprises reducing the number of I/O operations performed while processing the volume creation request by using the metadata. Metadata is reset to indicate all the portions associated with the new volume are non-initialized, without performing an I/O operation on the non-initialized portions of storage devices. One skilled in the art will recognize that some small number of I/O operations may be performed on the storage devices when updating any metadata persistently stored on the storage devices. When resetting the metadata, the bits in the bit tables for portions of the storage devices that comprise the new volume may be cleared to indicate that all the portions corresponding to the RAID volume are non-initialized.

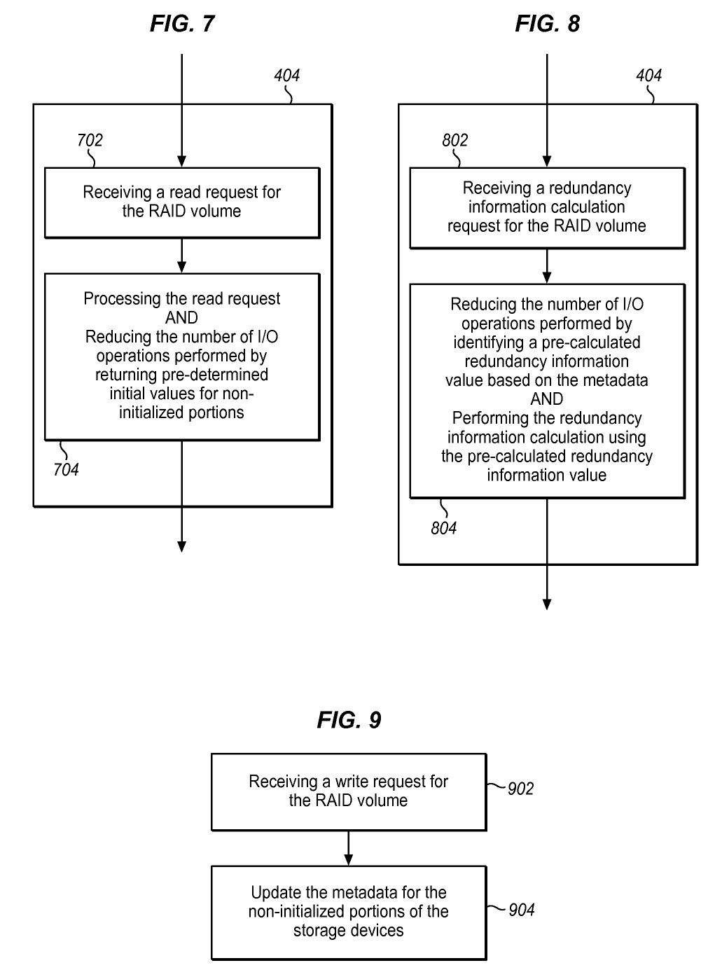

Step 702 of FIG. 7 comprises receiving a read request for the RAID volume. A read request is issued to return current data from an identified area of a RAID volume.

Step 704 comprises reducing the number of I/O operations performed while processing the read request by using the metadata. If portions of the read request correspond to non-initialized portions of storage devices as indicated in the metadata, then pre-determined initial values (e.g., zeros) are returned for the read request without performing an I/O operation on that storage device. Because non-initialized portions do not contain any valid data (i.e., there were not previously written or initialized within the current volume), performing an I/O operation on a storage device to read this portion is not necessary. Instead, the metadata can be analyzed to determine if any part of the read request corresponds with any non-initialized portions and predetermined values (e.g., zeros) can be returned for that part of the request without performing an I/O operation to read the non-initialized portion on the storage device.

Step 802 of FIG. 8 comprises receiving a redundancy information calculation for the RAID volume. A redundancy information calculation may be performed during a rebuild process as described above and/or during a write operation (e.g., during a read-modify-write operation).

Step 804 comprises reducing the number of I/O operations performed while processing the redundancy information by using the metadata. If, for example, the metadata indicated that some portions of the RAID volume involved in a redundancy information calculation are non-initialized, then the number of I/O operations may be reduced by utilizing pre-calculated redundancy values instead of performing read operations on the non-initialized portions of the RAID volume. For example, in RAID 5, pre-calculated zeros may be used for XOR calculations of non-initialized portions. In other redundancy information calculations, appropriate pre-calculated values may be used for one or more non-initialized values in a redundancy information calculation. Where pre-calculated values are used for redundancy information calculations, the corresponding portions need not be read from the storage devices.

FIG. 9 is a flowchart describing exemplary additional steps of the method of FIG. 4

Step 902 of FIG. 9 comprises receiving a write request for the RAID volume. For example, an entire stripe or portions of a stripe may be written as described above in regards to FIGS. 1-3.

Step 904 comprises updating the metadata for the portions of the storage devices determined to correspond to portions written in the write request. For example, if a stripe write is performed on stripe 206 of FIG. 2 to, then row 206′ of metadata 106 would be set to bit 1's to indicate that non-initialized portions P₁, Q₁, and R₁ are now initialized.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method operable in a storage controller for managing a Redundant Array of Independent Disks (RAID) volume, the method comprising:
associating metadata with storage devices that comprise the RAID volume, wherein the metadata identifies each of a plurality of portions of the storage devices as being either initialized or non-initialized; and
reducing the number of input/output (I/O) operations performed by the storage controller in response to a request for the RAID volume based on the metadata.

2. The method of claim 1 wherein:
the request comprises a rebuild request for the RAID volume; and
the step of reducing the number of I/O operations comprises:
identifying the initialized portions and the non-initialized portions of the storage devices from the metadata; and
performing a rebuild process on the RAID volume by writing data only to the initialized portions of the storage devices identified by the metadata.

3. The method of claim 1 wherein:
the request comprises a read request for the RAID volume; and
the step of reducing the number of I/O operations comprises:
determining from the metadata if any part of data requested by the read request corresponds to the non-initialized portions of the storage devices; and
returning a pre-determined initial value without performing an I/O operation on the storage devices for the part of the data requested by the read request determined to correspond to the non-initialized portions.

4. The method of claim 1 further comprising:
receiving a write request for the RAID volume;
updating the metadata for portions of the storage devices corresponding to portions written in the write request.

5. The method of claim 1 wherein:
the request comprises a volume creation request for the RAID volume; and
the step of reducing the number of I/O operations comprises resetting the metadata to indicate that a portion of a storage device within the RAID volume is non-initialized without performing an I/O operation on the portion of the storage device.

6. The method of claim 1 wherein:
the request comprises a redundancy information calculation request for the RAID volume; and
the step of reducing the number of I/O operations comprises:
identifying a pre-calculated redundancy information value based on the metadata; and
performing the redundancy information calculation using the pre-calculated redundancy information value.

7. A method operable in a storage controller for managing a Redundant Array of Independent Disks (RAID) volume, the method comprising:
associating metadata with storage devices that comprise the RAID volume, wherein the metadata identifies each of a plurality of portions of the storage devices as being either initialized or non-initialized;
performing a volume creation operation for the RAID volume by resetting the metadata to indicate that a portion of a storage device within the RAID volume is non-initialized without performing an I/O operation on the portion of the storage device;
performing a read operation on the RAID volume by:
determining from the metadata if any part of data requested by the read operation corresponds to the non-initialized portions of the storage devices; and
returning a pre-determined initial value without performing an I/O operation on the storage devices for the part of the data requested by the read operation determined to correspond to the non-initialized portions;
performing a write operation on the RAID volume by updating the metadata for the portions of the storage devices corresponding to portions written in the write operation.

8. The method of claim 7 further comprising:
performing a rebuild operation on the RAID volume by:
identifying the initialized portions and the non-initialized portions of the storage devices from the metadata; and
performing a rebuild process on the RAID volume by writing data only to the initialized portions of the storage devices identified by the metadata.

9. The method of claim 7 further comprising:
performing a redundancy information calculation on the RAID volume by:
identifying a pre-calculated redundancy information value based on the metadata; and
performing the redundancy information calculation using the pre-calculated redundancy information value.

10. A Redundant Array of Independent Disks (RAID) storage system comprising:
a plurality of storage devices comprising a RAID volume; and
a storage controller coupled with the plurality of storage devices, the storage controller comprising:
a request module operable to receive a request for the RAID volume;
an input/output (I/O) processing module operable to perform I/O operations for the storage devices in response to the I/O request and to reduce the number of I/O operations performed in response to the request for the RAID volume based on the metadata;
a metadata analyzing module coupled with the metadata storage module and the I/O processing module, the metadata analyzing module operable to identify the initialized portions and the non-initialized portions of the storage devices from the metadata;
a metadata storage module coupled with the I/O request module and the I/O processing module, the metadata storage module operable to store metadata associated with the storage devices, wherein the metadata identifies each of a plurality of portions of the storage devices as being either initialized or non-initialized; and
a metadata updating module coupled with the metadata storage module and the I/O processing module, the metadata updating module operable to update the metadata.

11. The RAID storage system of claim 10 wherein:
the request module is further operable to receive a rebuild request for the RAID volume; and
the I/O processing module, responsive to the request module receiving the rebuild request, is further operable to perform a rebuild process on the RAID volume by writing data only on the initialized portions of the storage devices identified by the metadata analyzer module.

12. The RAID storage system of claim 10 wherein:
the request module is further operable to receive a read request for the RAID volume;
the metadata analyzing module is further operable to determine from the metadata if any part of data requested by the read request corresponds to the non-initialized portions of the storage devices; and
the I/O processing module, responsive to the request module receiving the read request, is further operable to return a pre-determined initial value without performing an I/O operation on the storage devices for the part of the data requested by the read request determined by the metadata analyzing module to correspond to the non-initialized portions.

13. The RAID storage system of claim 12 wherein:
the request module is further operable to receive a write request for the RAID volume; and
the metadata updating module, responsive to the request module receiving the write request, is further operable to update metadata for the any part of the data written in the write request corresponding to portions of the storage devices.

14. The RAID storage system of claim 10 wherein:
the request module is further operable to receive a volume creation request for the RAID volume; and
the metadata updating module, responsive to the request module receiving the volume creation request, is further operable to reset the metadata to indicate that a portion of a storage device within the RAID volume is non-initialized without performing an I/O operation on the portion of the storage device.

15. The RAID storage system of claim 10 wherein:
the request module is further operable to receive a redundancy information calculation request for the RAID volume; and
the I/O processor module, responsive to the request module receiving the redundancy information calculation request, is further operable to identify a pre-calculated redundancy information value based on the metadata and to perform the redundancy information calculation using the pre-calculated redundancy information value.

16. The RAID storage system of claim 10 wherein:
the metadata storage module includes non-volatile memory; and
the metadata updating module is further operable to store the metadata in the non-volatile memory.

17. The RAID storage system of claim 16 wherein:
the metadata updating module is further operable to maintain an updated copy of the metadata on the storage devices by copying the metadata from the non-volatile memory to the storage devices.

18. The RAID storage system of claim 10 wherein:
the metadata updating module is further operable to store the metadata on the storage devices.
